(19) United States
(12) Patent Application Publication
(10) Pub. No.: US 2026/0146397 A1
(43) Pub. Date: May 28, 2026

(54) Mounting Device

(71) Applicant: Garrel Brewer, Lily, WI (US)

(72) Inventor: Garrel Brewer, Lily, WI (US)

(21) Appl. No.: 18/962,933

(22) Filed: Nov. 27, 2024

(51) Int. Cl. E01H 5/06; B60D 1/00; F16M 11/42

(52) U.S. Cl. CPC E01H 5/06; B60D 2001/008; F16M 11/42

(57) ABSTRACT

A mounting device for removably attaching a snow plow and a brush guard to a vehicle having a front bumper includes a vehicle mount that is coupled to the vehicle adjacent to the front bumper. An attachment adaptor is releasably couplable to the vehicle mount. An attachment is coupled to the attachment adaptor wherein the attachment is positionable forwardly from the front bumper of the vehicle when the attachment adaptor is coupled to the vehicle mount. A cart releasably retains the attachment wherein the cart facilitates positioning the attachment adjacent to the vehicle for coupling the attachment adaptor to the vehicle mount.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to mounts and more particularly pertains to a new mount for removably attaching a snow plow and a brush guard to a vehicle.

### (2) Description of Related Art including information disclosed under 37 CFR 1.97 and 1.98.

The prior art relates to mounts. More specifically, the prior art relates to mounting devices for attaching structures such as snow plows and brush guards to vehicles. Typically, the brackets or other mounting devices are designed specifically for the structure that is being attached to the vehicle. For example, the prior art discloses snowplow mounts that are designed to couple snow plows to vehicles. When the user wants to switch out the snow plow for another structure, such as a brush guard, the user needs to remove the entire mount and replace it with a different device that is designed for use with the brush guard. This process is both time consuming and expensive, because users need to purchase different mounting devices for each different structure they want to use. Thus, there is a need for a universal mounting device that can be used for both snow plows and brush guards. Because these attachable structures are typically very heavy and difficult to move around, the universal mounting device would ideally be designed for use with a stand that could hold the attachable structure and that could facilitate coupling the structure to the universal mounting device.

### (h) Brief Summary of the Invention

An embodiment of the disclosure meets the needs presented above by generally comprising a vehicle having a front bumper. A vehicle mount is coupled to the vehicle adjacent to the front bumper. An attachment adaptor is releasably couplable to the vehicle mount. An attachment is coupled to the attachment adaptor wherein the attachment is positionable forwardly from the front bumper of the vehicle when the attachment adaptor is coupled to the vehicle mount. A cart releasably retains the attachment wherein the cart facilitates positioning the attachment adjacent to the vehicle for coupling the attachment adaptor to the vehicle mount.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a mounting device according to an embodiment of the disclosure.

FIG. 2 is a front isometric view of an embodiment of the disclosure.

FIG. 3 is a front view of an embodiment of the disclosure.

FIG. 4 is a top view of an embodiment of the disclosure.

FIG. 5 is a side view of an embodiment of the disclosure.

FIG. 6 is a rear view of an embodiment of the disclosure.

FIG. 7 is a front isometric view of an embodiment of the disclosure.

FIG. 8 is a front isometric view of an embodiment of the disclosure.

FIG. 9 is a side view of an embodiment of the disclosure.

FIG. 10 is a front isometric view of an embodiment of the disclosure.

FIG. 11 is an in-use view of an embodiment of the disclosure.

FIG. 12 is an in-use view of an embodiment of the disclosure.

FIG. 13 is an in-use view of an embodiment of the disclosure.

FIG. 14 is an in-use view of an embodiment of the disclosure.

FIG. 15 is an in-use view of an embodiment of the disclosure.

### (j) DETAILED DESCRIPTION OF THE INVENTION

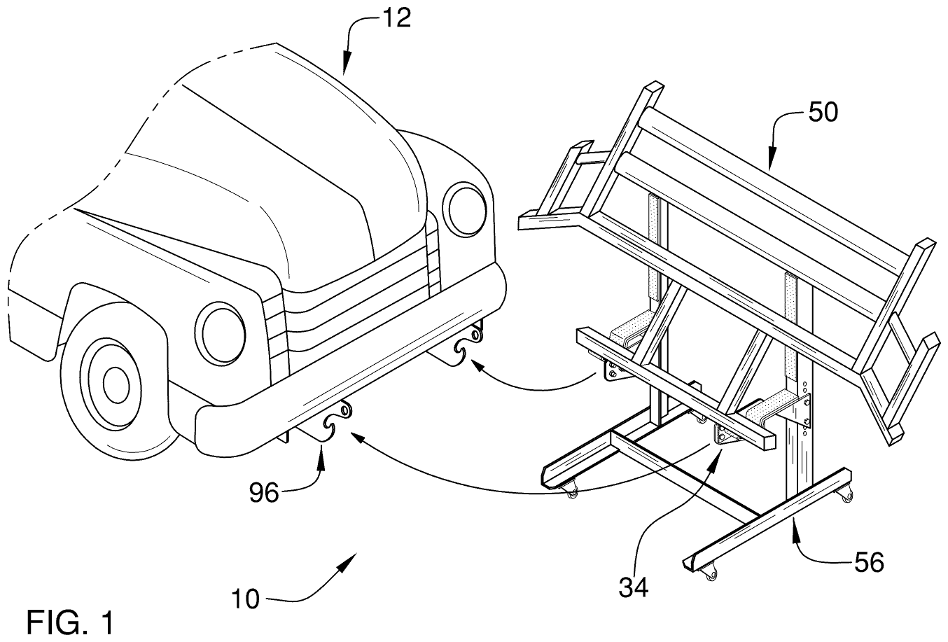

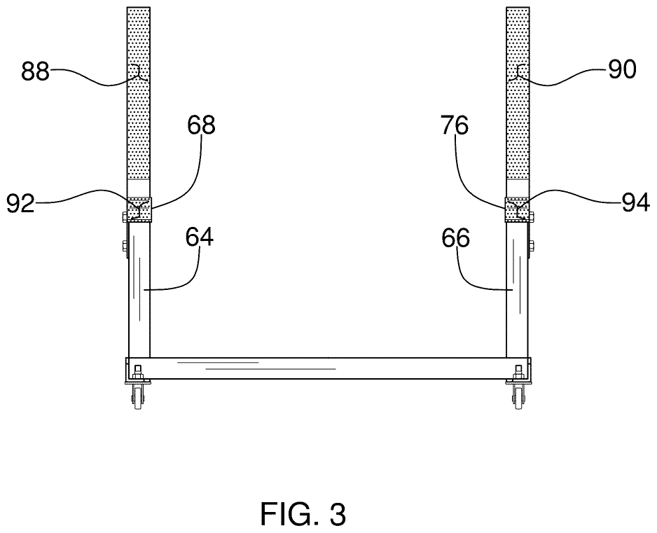

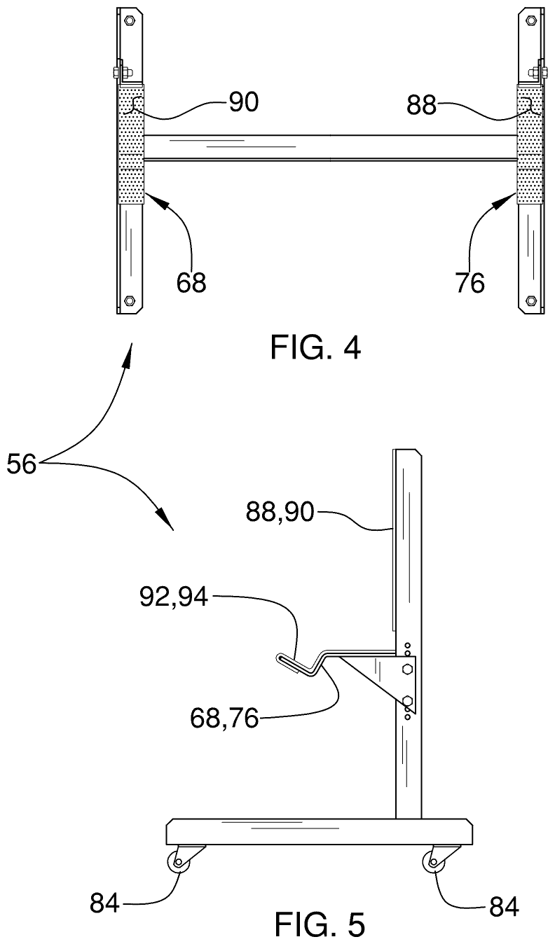

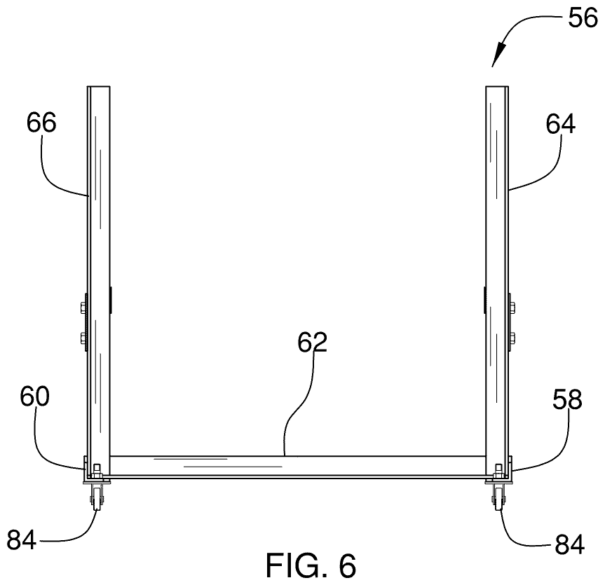

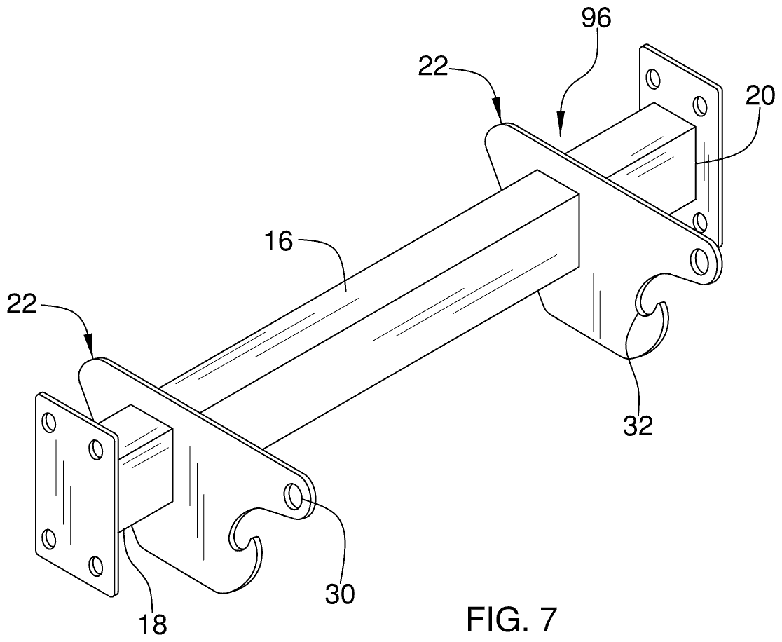

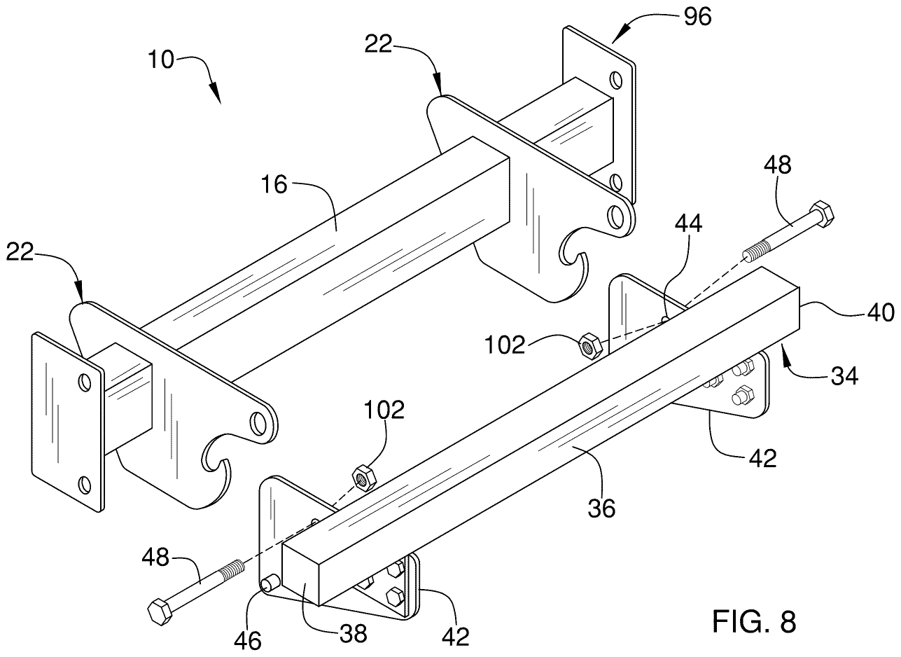

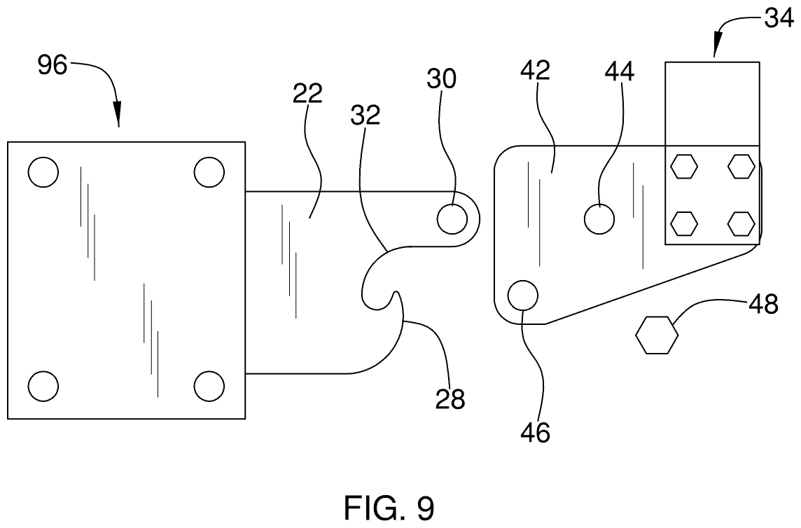

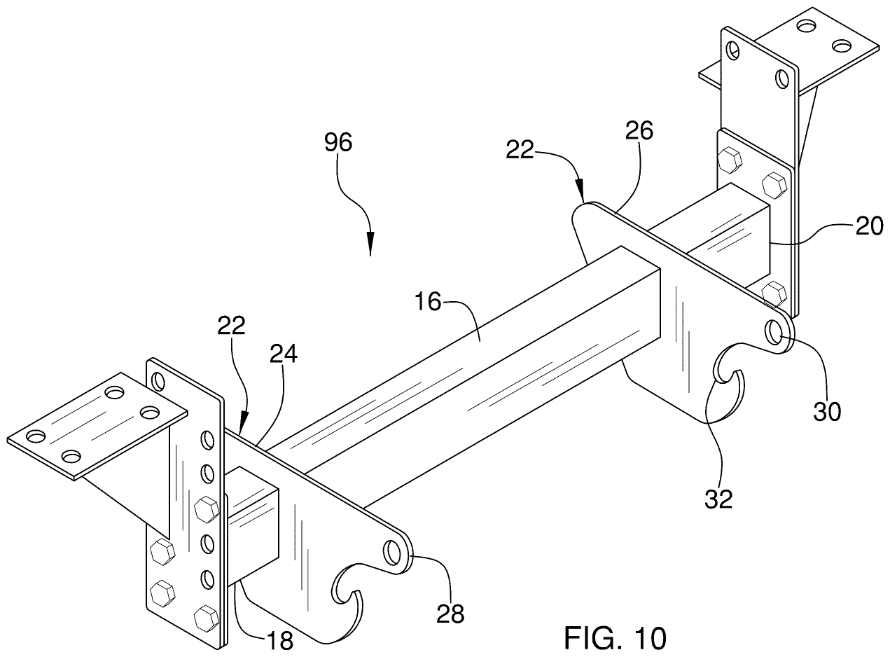

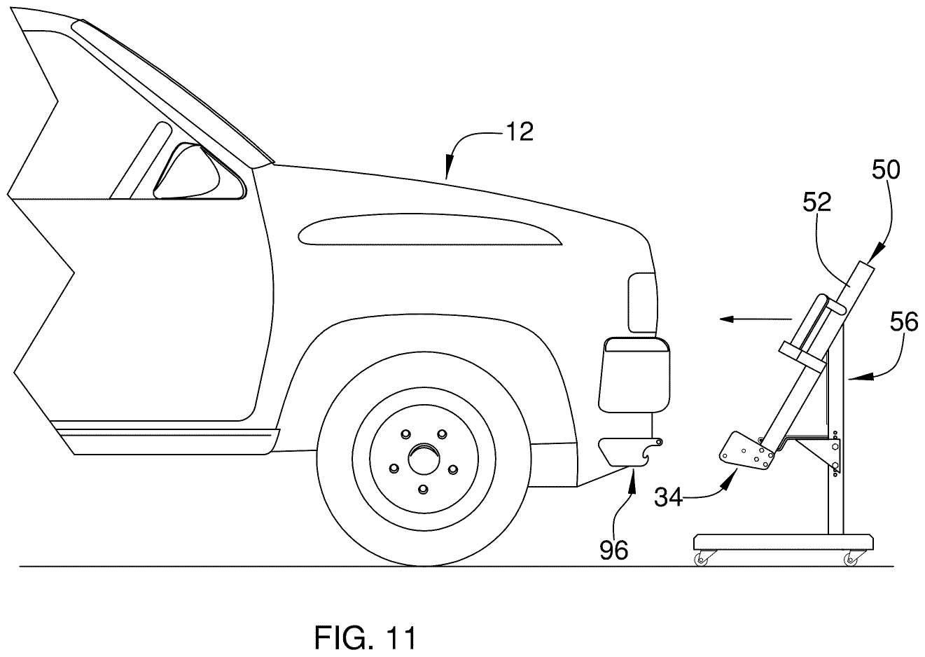

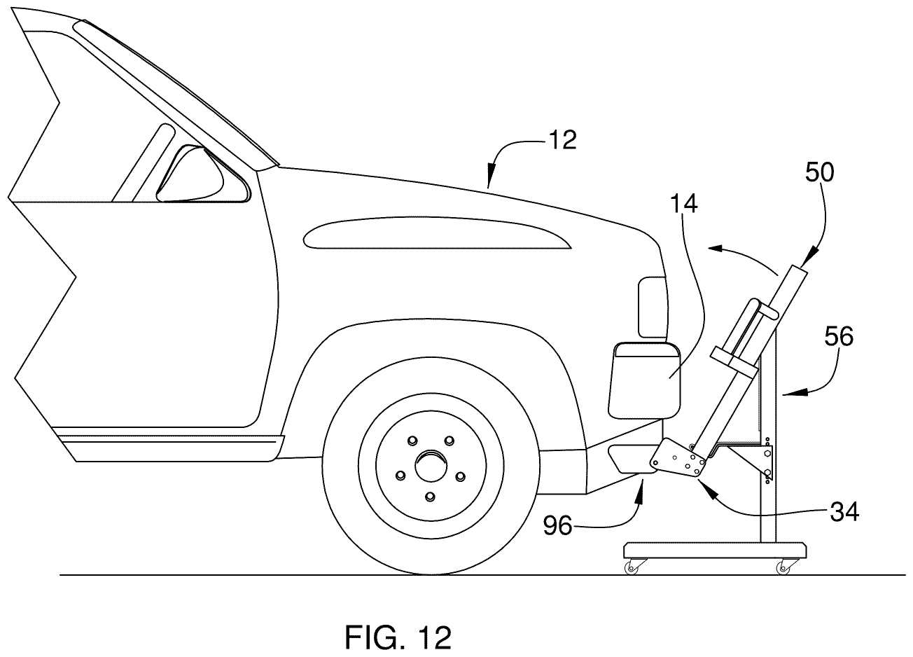

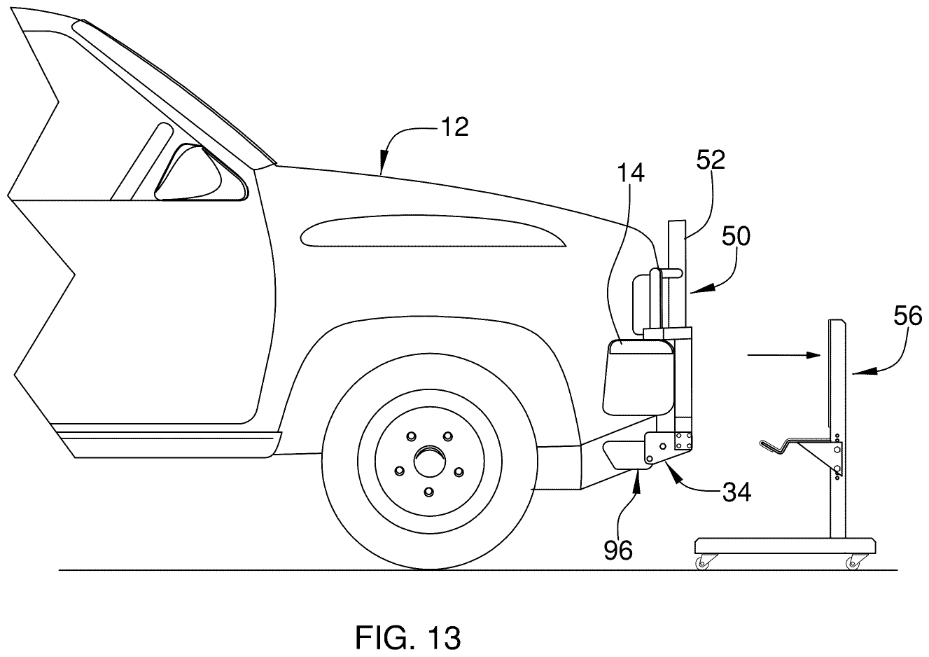

With reference now to the drawings, and in particular to FIGS. 1 through 15 thereof, a new mount embodying the principles and concepts of an embodiment of the disclosure and generally designated by the reference numeral 10 will be described.

As best illustrated in FIGS. 1 through 15, the mounting device 10 generally comprises a vehicle 12 which has a front bumper 14. A vehicle mount 96 is coupled to the vehicle 12 adjacent to the front bumper 14. The vehicle mount 96 may include a vehicle mount rail 16 that has a vehicle mount rail first end 18 and a vehicle mount rail second end 20.

A pair of vehicle mount plates 22 are generally coupled to and extend outwardly from the vehicle mount rail 16. The pair of vehicle mount plates 22 are generally spaced from each other. For example, a first vehicle mount plate 24 of the pair of vehicle mount plates 22 may be positioned proximate to the vehicle mount rail first end 18. A second vehicle mount plate 26 of the pair of vehicle mount plates 22 may be positioned proximate to the vehicle mount rail second end 20. Each vehicle mount plate of the pair of vehicle mount plates 22 generally has a vehicle mount plate forward edge 28 that is spaced from the vehicle mount rail 16.

A vehicle mount aperture 30 may extend through each vehicle mount plate of the pair of vehicle mount plates 22. The vehicle mount aperture 30 may be positioned adjacent to the vehicle mount plate forward edge 28 of each vehicle mount plate of the pair of vehicle mount plates 22. In such embodiments, the vehicle mount aperture 30 is generally spaced from the vehicle mount rail 16. The vehicle mount aperture 30 that extends through the first vehicle mount plate 24 may be aligned with the vehicle mount aperture 30 extending through the second vehicle mount plate 26.

A vehicle mount slot 32 may extend into the vehicle mount plate forward edge 28 of each vehicle mount plate of the pair of vehicle mount plates 22. The vehicle mount slot 32 may be positioned proximate to the vehicle mount aperture 30. The vehicle mount slot 32 that extends into the first vehicle mount plate 24 may be aligned with the vehicle mount slot 32 that extends into the second vehicle mount plate 26.

An attachment adaptor 34 is releasably couplable to the vehicle mount 96. The attachment adaptor 34 may generally include an attachment adaptor rail 36. The attachment adaptor rail 36 may have an attachment adaptor rail first end 38 and an attachment adaptor rail second end 40.

A pair of attachment adaptor plates 42 may be coupled to and extend outwardly from the attachment adaptor rail 36. The pair of attachment adaptor plates 42 may be spaced from each other by a distance that is complementary to a distance between the pair of vehicle mount plates 22. For example, each attachment adaptor plate of the pair of attachment adaptor plates 42 may be positionable in contact with a respective vehicle mount plate of the pair of vehicle mount plates 22 while the attachment adaptor 34 is coupled to the vehicle mount 96.

An attachment adaptor aperture 44 may extend through each attachment adaptor plate of the pair of attachment adaptor plates 42. The attachment adaptor aperture 44 of each attachment adaptor plate is generally aligned with a respective vehicle mount aperture 30 of the respective vehicle mount plate of the pair of vehicle mount plates 22 while the attachment adaptor 34 is coupled to the vehicle mount 96.

An attachment adaptor peg 46 may be coupled to and extend outwardly from each attachment adaptor plate of the pair of attachment adaptor plates 42. The attachment adaptor peg 46 may be perpendicular to each attachment adaptor plate of the pair of attachment adaptor plates 42. The attachment adaptor peg 46 generally has a size that is complementary to a size of the vehicle mount slot 32 wherein the attachment adaptor peg 46 is positionable within the vehicle mount slot 32 to releasably couple the attachment adaptor 34 to the vehicle mount 96. In one exemplary embodiment, the attachment adaptor peg 46 may be welded to each attachment adaptor plate of the pair of attachment adaptor plates 42. In another exemplary embodiment, the attachment adaptor peg 46 may be integrally formed with each attachment adaptor plate of the pair of attachment adaptor plates 42.

A fastener 48 may be positionable to extend through the attachment adaptor aperture 44 and the vehicle mount aperture 30 to releasably secure the attachment adaptor 34 to the vehicle mount 96. In other words, the mounting device 10 may include a pair of fasteners 48. A first fastener of the pair of fasteners 48 may extend through the vehicle mount aperture 30 on the first vehicle mount plate 24 and through the attachment adaptor aperture 44 on a first attachment adaptor plate of the pair of attachment adaptor plates 42. A second fastener of the pair of fasteners 48 may extend through the vehicle mount aperture 30 on the second vehicle mount plate 26 and through the attachment adaptor aperture 44 on a second attachment adaptor plate of the pair of attachment adaptor plates 42.

The fastener 48 may secure the pair of vehicle mount plates 22 to the pair of attachment adaptor plates 42. In preferred embodiments, the fastener 48 is a bolt having an external threading that is threadably couplable to a retainer 102, such as a nut. Such embodiments are preferred because the threaded coupling between the fastener 48 and the retainer 102 inhibits the fastener 48 from loosening and falling out of the attachment adaptor aperture 44 while the vehicle 12 is being driven.

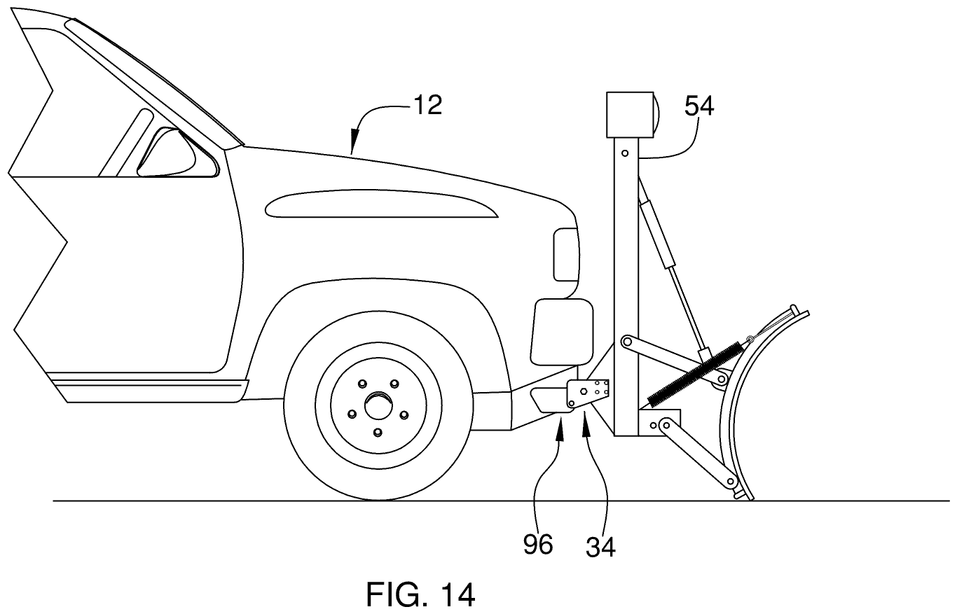

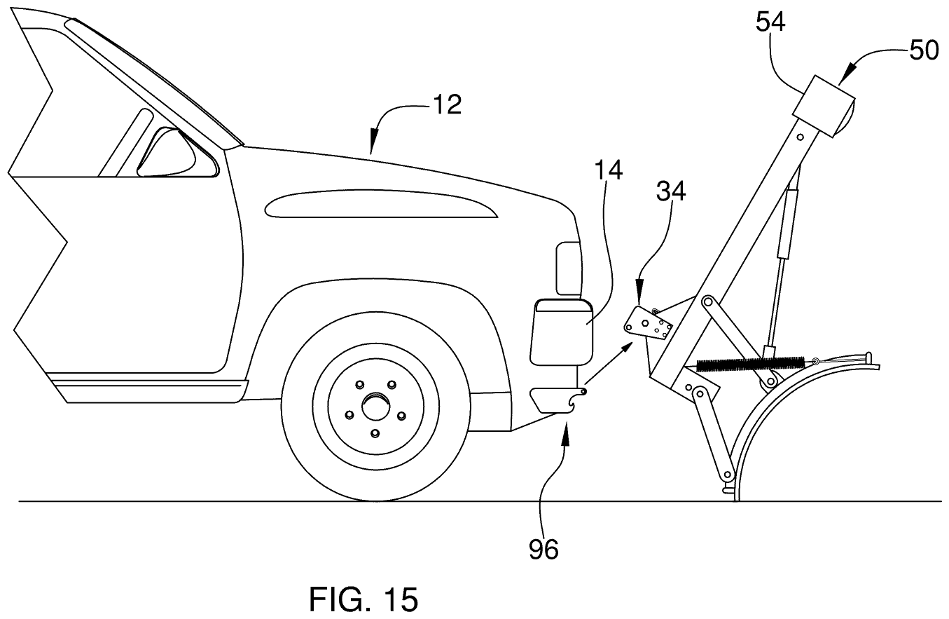

An attachment 50 is coupled to the attachment adaptor 34 wherein the attachment 50 is positionable forwardly from the front bumper 14 of the vehicle 12 when the attachment adaptor 34 is coupled to the vehicle mount 96. For example, the attachment 50 may comprise a brush guard 52, as shown in FIGS. 1, 11, 12, and 13. Alternatively, the attachment 50 may comprise a snow plow 54, as shown in FIGS. 14 and 15. When a user wants to use the vehicle 12 for snow removal, the user can select the snow plow 54 as the attachment 50. When the user wants to protect the vehicle 12 from impact damage which could be caused by road debris or by a collision with an animal such as a deer, the user can select the brush guard 52 as the attachment 50. Both the snow plow 54 and the brush guard 52 may be coupled to a respective attachment adaptor 34. Either the snow plow 54 or the brush guard 52 can be releasably coupled to the vehicle 12 using the same vehicle mount 96.

A cart 56 may releasably retain the attachment 50 wherein the cart 56 facilitates positioning the attachment 50 adjacent to the vehicle 12 for coupling the attachment adaptor 34 to the vehicle mount 96. The cart 56 may be particularly useful when the attachment 50 is the brush guard 52. In some embodiments, the cart 56 is only used for the brush guard 52 and is not used for the snow plow 54. For example, the cart 56 may include a base frame first rail 58 that is spaced from a base frame second rail 60. The base frame first rail 58 may be parallel to the base frame second rail 60.

A base frame plate 62 may be coupled to and extend between the base frame first rail 58 and the base frame second rail 60. The base frame plate 62 may be perpendicular to each of the base frame first rail 58 and the base frame second rail 60.

A first column 64 may be coupled to and extend upwardly from the base frame first rail 58. The first column 64 may be perpendicular to the base frame first rail 58. The first column 64 may be spaced from the base frame plate 62.

A second column 66 may be coupled to and extend upwardly from the base frame second rail 60. The second column 66 may be perpendicular to the base frame second rail 60. The second column 66 may be aligned with the first column 64. The second column 66 may also be parallel to the first column 64.

A first arm 68 may be coupled to the first column 64. The first arm 68 may extend outwardly from the first column 64. The first arm 68 is generally spaced from the base frame first rail 58.

For example, the first arm 68 may include a first arm primary member 70 that extends outwardly from the first column 64. For example, the first arm primary member 70 may be perpendicular to the first column 64. A first arm secondary member 72 may be coupled to the first arm primary member 70. The first arm secondary member 72 is generally positioned on the first arm primary member 70 distally to the first column 64. The first arm secondary member 72 may be angled to extend outwardly from the first arm primary member 70 and downwardly, toward the base frame first rail 58. A first arm tertiary member 74 may be coupled to the first arm secondary member 72 and is generally positioned distally to the first arm primary member 70. The first arm tertiary member 74 may be angled to extend outwardly from the first arm secondary member 72 and upwardly, away from the base frame first rail 58.

A second arm 76 may be coupled to the second column 66. The second arm 76 generally extends outwardly from the second column 66. The second arm 76 may be aligned with the first arm 68.

For example, the second arm 76 may include a second arm primary member 78 that extends outwardly from the second column 66. The second arm primary member 78 may be perpendicular to the second column 66. The second arm primary member 78 may be coplanar with the first arm primary member 70. A second arm secondary member 80 may be coupled to the second arm primary member 78 and is generally positioned distally relative to the second column 66. The second arm secondary member 80 may be angled to extend outwardly from the second arm primary member 78 and downwardly, toward the base frame second rail 60. The second arm secondary member 80 may be coplanar with the first arm secondary member 72. A second arm tertiary member 82 may be coupled to the second arm secondary member 80 and is generally positioned distally to the second arm primary member 78. The second arm tertiary member 82 may be angled to extend outwardly from the second arm secondary member 80 and upwardly, away from the base frame second rail 60. The second arm tertiary member 82 may be coplanar with the first arm tertiary member 74.

A plurality of wheels 84 may be operably coupled to the base frame first rail 58 and the base frame second rail 60 of the cart 56 to facilitate movement of the cart 56. For example, each wheel of the plurality of wheels 84 may comprise a castor wheel wherein the plurality of wheels 84 are pivotable to facilitate multi-directional movement of the cart 56.

A padding 86 may be coupled to the cart 56. The padding 86 may comprise a resiliently compressible material wherein the padding 86 is configured to inhibit impact damage between the cart 56 and the attachment 50.

For example, the padding 86 may include a padding first member 88 that is positioned on the first column 64. The padding first member 88 may be aligned with the first arm 68. In other words, the padding first member 88 may be positioned on the same side of the first column 64 as the first arm 68. The first arm 68 may be positioned between the base frame first rail 58 and the padding first member 88, wherein the padding first member 88 is positioned above the first arm 68.

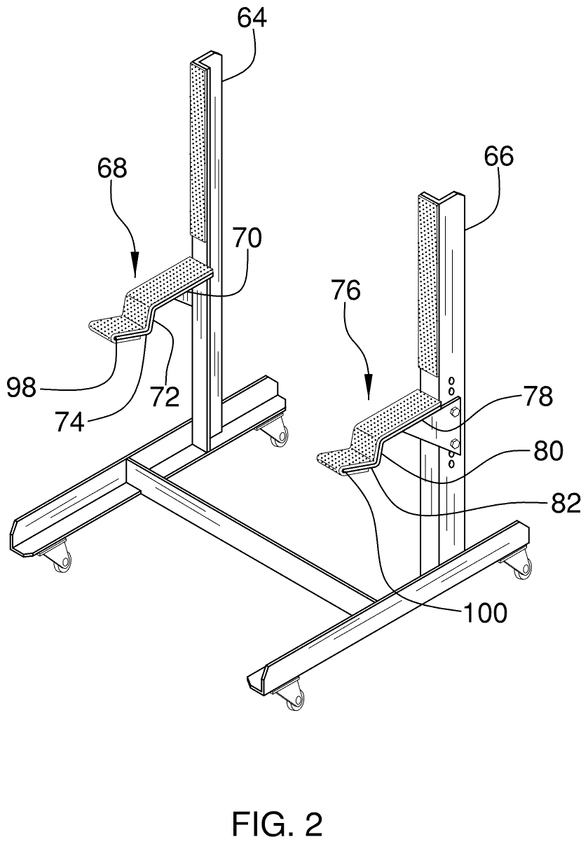

A padding second member 90 may be positioned on the second column 66. The padding second member 90 may be aligned with the padding first member 88. As shown in FIG. 2, the padding second member 90 may be positioned on the same side of the second column 66 as the second arm 76, such that the padding second member 90 is aligned with the second arm 76. The padding second member 90 may also be positioned above the second arm 76 wherein the second arm 76 is positioned between the padding second member 90 and the base frame second rail 60.

A padding third member 92 may be positioned on the first arm 68. The padding third member 92 may cover an upper surface of the first arm 68. The padding third member 92 may also extend over a first arm free edge 98 of the first arm tertiary member 74 to a lower surface of the first arm 68.

A padding fourth member 94 may be positioned on the second arm 76. The padding fourth member 94 may cover a top surface of the second arm 76. The padding fourth member 94 may also extend over a second arm free edge 100 of the second arm tertiary member 82 to a bottom surface of the second arm 76.

In use, the user can select which embodiment of the attachment 50 to couple to the vehicle 12 using the vehicle mount 96 and the attachment adaptor 34. For example, as shown in FIG. 1, the user may store the attachment 50 on the cart 56 while the attachment 50 is not coupled to the vehicle 12. The user may position the cart 56 in front of the front bumper 14 and align the attachment adaptor 34 on the attachment 50 to the vehicle mount 96 on the vehicle 12. The attachment adaptor peg 46 may slide into the vehicle mount slot 32. The pin 48 may be positioned to extend through attachment adaptor aperture 44 and the vehicle mount aperture 30, securing the attachment 50 to the vehicle 12. The vehicle mount 96 can remain coupled to the vehicle 12 proximate to the front bumper 14, allowing the user to switch out various embodiments of the attachment 50, such as the brush guard 52 and the snow plow 54, as needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An attachment mounting system comprising:
a vehicle having a front bumper;
a vehicle mount being coupled to the vehicle adjacent to the front bumper;
an attachment adaptor being releasably couplable to the vehicle mount;
an attachment being coupled to the attachment adaptor wherein the attachment is positionable forwardly from the front bumper of the vehicle when the attachment adaptor is coupled to the vehicle mount; and
a cart releasably retaining the attachment wherein the cart facilitates positioning the attachment adjacent to the vehicle for coupling the attachment adaptor to the vehicle mount.

2. The attachment mounting system of claim 1, the attachment further comprising a brush guard.

3. The attachment mounting system of claim 1, the attachment further comprising a snow plow.

4. The attachment mounting system of claim 1, the vehicle mount further comprising:
a vehicle mount rail having a vehicle mount rail first end and a vehicle mount rail second end; and
a pair of vehicle mount plates being coupled to and extending outwardly from the vehicle mount rail, the pair of vehicle mount plates being spaced from each other, the pair of vehicle mount plates including a first vehicle mount plate and a second vehicle mount plate.

5. The attachment mounting system of claim 4, wherein the first vehicle mount plate of the pair of vehicle mount plates is positioned proximate to the vehicle mount rail first end and wherein the second vehicle mount plate of the pair of vehicle mount plates is positioned proximate to the vehicle mount rail second end.

6. The attachment mounting system of claim 4, the attachment adaptor further comprising:
an attachment adaptor rail; and
a pair of attachment adaptor plates being coupled to and extending outwardly from the attachment adaptor rail, the pair of attachment adaptor plates being spaced from each other by a distance being complementary to a distance between the pair of vehicle mount plates.

7. The attachment mounting system of claim 6, wherein each attachment adaptor plate of the pair of attachment adaptor plates is positionable in contact with a respective vehicle mount plate of the pair of vehicle mount plates while the attachment adaptor is coupled to the vehicle mount.

8. The attachment mounting system of claim 6, the vehicle mount further comprising:
each vehicle mount plate of the pair of vehicle mount plates having a vehicle mount plate forward edge being spaced from the vehicle mount rail; and
a vehicle mount slot extending into the vehicle mount plate forward edge of each vehicle mount plate of the pair of vehicle mount plates.

9. The attachment mounting system of claim 8, wherein the vehicle mount slot extending into the first vehicle mount plate is aligned with the vehicle mount slot extending into the second vehicle mount plate.

10. The attachment mounting system of claim 8, the attachment adaptor further comprising an attachment adaptor peg being coupled to and extending outwardly from each attachment adaptor plate of the pair of attachment adaptor plates, the attachment adaptor peg having a size being complementary to a size of the vehicle mount slot wherein the attachment adaptor peg is positionable within the vehicle mount slot to releasably couple the attachment adaptor to the vehicle mount.

11. The attachment mounting system of claim 6, the vehicle mount further comprising a vehicle mount aperture extending through each vehicle mount plate of the pair of vehicle mount plates
12. The attachment mounting system of claim 11, wherein the vehicle mount aperture extending through the first vehicle mount plate is aligned with the vehicle mount aperture extending through the second vehicle mount plate.

13. The attachment mounting system of claim 11, the attachment adaptor further comprising an attachment adaptor aperture extending through each attachment adaptor plate of the pair of attachment adaptor plates, the attachment adaptor aperture being aligned with a respective vehicle mount aperture of the respective vehicle mount plate of the pair of vehicle mount plates while the attachment adaptor is coupled to the vehicle mount.

14. The attachment mounting system of claim 13, further comprising a fastener being positionable to extend through the attachment adaptor aperture and the vehicle mount aperture to releasably secure the attachment adaptor to the vehicle mount.

15. An attachment mounting system comprising:
a vehicle having a front bumper;
a vehicle mount being coupled to the vehicle adjacent to the front bumper, the vehicle mount including:
a vehicle mount rail having a vehicle mount rail first end and a vehicle mount rail second end;
a pair of vehicle mount plates being coupled to and extending outwardly from the vehicle mount rail, the pair of vehicle mount plates being spaced from each other wherein a first vehicle mount plate of the pair of vehicle mount plates is positioned proximate to the vehicle mount rail first end and wherein a second vehicle mount plate of the pair of vehicle mount plates is positioned proximate to the vehicle mount rail second end, each vehicle mount plate of the pair of vehicle mount plates having a vehicle mount plate forward edge being spaced from the vehicle mount rail;
a vehicle mount aperture extending through each vehicle mount plate of the pair of vehicle mount plates, the vehicle mount aperture being positioned adjacent to the vehicle mount plate forward edge of each vehicle mount plate of the pair of vehicle mount plates wherein the vehicle mount aperture is spaced from the vehicle mount rail, the vehicle mount aperture extending through the first vehicle mount plate being aligned with the vehicle mount aperture extending through the second vehicle mount plate; and
a vehicle mount slot extending into the vehicle mount plate forward edge of each vehicle mount plate of the pair of vehicle mount plates, the vehicle mount slot being positioned proximate to the vehicle mount aperture, the vehicle mount slot extending into the first vehicle mount plate being aligned with the vehicle mount slot extending into the second vehicle mount plate;
an attachment adaptor being releasably couplable to the vehicle mount, the attachment adaptor including:
an attachment adaptor rail having an attachment adaptor rail first end and an attachment adaptor rail second end;
a pair of attachment adaptor plates being coupled to and extending outwardly from the attachment adaptor rail, the pair of attachment adaptor plates being spaced from each other by a distance being complementary to a distance between the pair of vehicle mount plates wherein each attachment adaptor plate of the pair of attachment adaptor plates is positionable in contact with a respective vehicle mount plate of the pair of vehicle mount plates while the attachment adaptor is coupled to the vehicle mount;
an attachment adaptor aperture extending through each attachment adaptor plate of the pair of attachment adaptor plates, the attachment adaptor aperture being aligned with a respective vehicle mount aperture of the respective vehicle mount plate of the pair of vehicle mount plates while the attachment adaptor is coupled to the vehicle mount; and
an attachment adaptor peg being coupled to and extending outwardly from each attachment adaptor plate of the pair of attachment adaptor plates, the attachment adaptor peg being perpendicular to each attachment adaptor plate of the pair of attachment adaptor plates, the attachment adaptor peg having a size being complementary to a size of the vehicle mount slot wherein the attachment adaptor peg is positionable within the vehicle mount slot to releasably couple the attachment adaptor to the vehicle mount;
a fastener being positionable to extend through the attachment adaptor aperture and the vehicle mount aperture to releasably secure the attachment adaptor to the vehicle mount;
an attachment being coupled to the attachment adaptor wherein the attachment is positionable forwardly from the front bumper of the vehicle when the attachment adaptor is coupled to the vehicle mount;
a cart releasably retaining the attachment wherein the cart facilitates positioning the attachment adjacent to the vehicle for coupling the attachment adaptor to the vehicle mount, the cart including:
a base frame first rail being spaced from a base frame second rail, the base frame first rail being parallel to the base frame second rail;
a base frame plate being coupled to and extending between the base frame first rail and the base frame second rail, the base frame plate being perpendicular to each of the base frame first rail and the base frame second rail;
a first column being coupled to and extending upwardly from the base frame first rail, the first column being perpendicular to the base frame first rail, the first column being spaced from the base frame plate;
a second column being coupled to and extending upwardly from the base frame second rail, the second column being perpendicular to the base frame second rail, the second column being aligned with the first column;
a first arm being coupled to the first column, the first arm extending outwardly from the first column, the first arm being spaced from the base frame first rail, the first arm including:
a first arm primary member being perpendicular to the first column;
a first arm secondary member being coupled to the first arm primary member distally to the first column, the first arm secondary member being angled to extend outwardly from the first arm primary member and downwardly toward the base frame first rail; and
a first arm tertiary member being coupled to the first arm secondary member distally to the first arm primary member, the first arm tertiary member being angled to extend outwardly from the first arm secondary member and upwardly from the base frame first rail; and
a second arm being coupled to the second column, the second arm extending outwardly from the second column, the second arm being aligned with the first arm, the second arm including:
a second arm primary member being perpendicular to the second column, the second arm primary member being coplanar with the first arm primary member;
a second arm secondary member being coupled to the second arm primary member distally to the second column, the second arm secondary member being angled to extend outwardly from the second arm primary member and downwardly toward the base frame second rail wherein the second arm secondary member is coplanar with the first arm secondary member; and
a second arm tertiary member being coupled to the second arm secondary member distally to the second arm primary member, the second arm tertiary member being angled to extend outwardly from the second arm secondary member and upwardly from the base frame second rail wherein the second arm tertiary member is coplanar with the first arm tertiary member;
a plurality of wheels being operably coupled to the base frame first rail and the base frame second rail of the cart to facilitate movement of the cart, each wheel of the plurality of wheels comprising a castor wheel wherein the plurality of wheels are pivotable to facilitate multi-directional movement of the cart; and
a padding being coupled to the cart, the padding comprising a resiliently compressible material wherein the padding is configured to inhibit impact damage between the cart and the attachment, the padding including:
a padding first member being positioned on the first column, the padding first member being aligned with the first arm, the first arm being positioned between the base frame first rail and the padding first member;
a padding second member being positioned on the second column, the padding second member being aligned with the padding first member;
a padding third member being positioned on the first arm, the padding third member covering an upper surface of the first arm, the padding third member extending over a first arm free edge of the first arm tertiary member to a lower surface of the first arm; and
a padding fourth member being positioned on the second arm, the padding fourth member covering a top surface of the second arm, the padding fourth member extending over a second arm free edge of the second arm tertiary member to a bottom surface of the second arm.

16. The attachment mounting system of claim 15, the attachment further comprising a brush guard.

17. The attachment mounting system of claim 15, the attachment further comprising a snow plow.
